(19) United States
(12) Patent Application Publication
(10) Pub. No.: US 2025/0238954 A1
(43) Pub. Date: Jul. 24, 2025

(54) POLARIZATION ORIENTATION METHOD BASED ON SKY REGION PRIOR AND MORPHOLOGICAL TEMPLATE MATCHING OF TRANSFORM DOMAIN

(71) Applicant: NORTH UNIVERSITY OF CHINA, Taiyuan (CN)

(72) Inventors: Jun TANG, Taiyuan (CN); Xindong WU, Taiyuan (CN); Chong SHEN, Taiyuan (CN); Huiliang CAO, Taiyuan (CN); Chenguang WANG, Taiyuan (CN); Jun LIU, Taiyuan (CN)

(73) Assignee: NORTH UNIVERSITY OF CHINA, Taiyuan (CN)

(21) Appl. No.: 18/653,735

(22) Filed: May 2, 2024

(30) Foreign Application Priority Data
Jan. 18, 2024 (CN) 2024100802839

(51) Int. Cl. G06T 7/73; G06V 10/762; G06V 20/10

(52) U.S. Cl. CPC G06T 7/74; G06V 10/762; G06V 20/10; G06T 2207/10024; G06T 2207/20048; G06T 2207/20072

(57) ABSTRACT

A polarization orientation method based on sky region prior and morphological template matching of transform domain, which reduces an interference of reflected light through the sky region prior and solves sun blur through the morphological template matching of transform domain (MTMTD); a region division standard is given through prior knowledge of a sky region, and the sky region is identified by clustering darkest pixel images in 15-channel polarization images; meanwhile, the MTMTD strategy provided carries out a transform domain treatment on an image of the angle of polarization by an imaging method, and solves the problem of sun blur under a single Rayleigh scattering model without relying on an additional sensor.

### CROSS-REFERENCE TO RELATED APPLICATIONS

This application claims priority to Chinese Patent Application Ser. No. CN2024100802839 filed on 18 Jan. 2024.

### TECHNICAL FIELD

The present invention belongs to the technical field of navigation, and particularly relates to a polarization orientation method based on sky region prior and morphological template matching of transform domain.

### BACKGROUND

Researches show that an angle of polarization (AOP) predicted by a single Rayleigh scattering model has robustness and contains a lot of navigation information, so that accurate course angle measurement can be completed. However, current orientation methods are often extremely sensitive to local polarization, which will increase a calculation error, especially when reflected light of objects such as trees and buildings destroys an AOP model. Although a gradient of a degree of polarization and other methods have been provided in the prior art, it should be noted that an occluded object with a flat characteristic cannot be identified by this method. Another key problem is that the direct use of the angle of polarization (AOP) for navigation may cause sun blur, because a range of the angle of polarization is only a half of a range of a course angle. Therefore, this method needs additional information to detect the sun blur, which undoubtedly increases a navigation cost.

### SUMMARY

Object of invention: in order to solve the problems that an orientation method in the prior art has poor accuracy due to an interference of reflected light and a navigation cost needs to be increased to solve sun blur, the present invention provides a polarization orientation method based on sky region prior and morphological template matching of transform domain.

Technical solution: a polarization orientation method based on sky region prior and morphological template matching of transform domain comprises a computer readable medium operable on a computer with memory for the polarization orientation method based on sky region prior and morphological template matching of transform domain, and comprising program instructions for executing the following steps of:
(1) calculating a polarization dark channel image, a degree of polarization, a gradient of the degree of polarization and a gradient of an angle of polarization by using 0°, 45°, 90° and 135° images shot by a polarization camera, calculating a light intensity binary image and an occlusion binary image according to the polarization dark channel image, calculating a binary image of the degree of polarization according to the degree of polarization, and calculating a gradient binary image according to the gradient of the degree of polarization and the gradient of the angle of polarization;
(2) setting a number of clusters according to the light intensity binary image and the occlusion binary image;
(3) carrying out polarization dark channel clustering according to the set number of clusters to obtain a polarization dark channel clustergram, and acquiring a sky region image through the polarization dark channel clustergram;
(4) calculating an image of the angle of polarization, and carrying out feature extraction on the image of the angle of polarization to obtain a feature binary image of the angle of polarization;
(5) constructing a two-dimensional plane by taking (0°, 360°] and [−90°, 90°] as horizontal and vertical directions respectively, and projecting the feature binary image of the angle of polarization onto the two-dimensional plane by a space domain transform method to obtain a sun position binary feature map;
(6) obtaining a sun position and a reverse sun position by matching according to the sun position binary feature map, and determining a real sun position according to a constraint condition that the sun is above a horizontal plane;
(7) ignoring a difference between a Rayleigh scattering model and a real atmospheric model, calculating a sun position deviation, and considering a detection result to be true and reliable when the deviation is less than a threshold Tₘ; and considering the detection result to be unreliable when the deviation is greater than the threshold;
(8) calculating a course angle by combining the angle of polarization with the sky region image; and
(9) providing a transform domain model for an angle of polarization, introduces template matching to solve a sun blur of a binary feature map that resulted in an accurate sky region based on the polarization orientation method, therefore, improving a robustness of orientation.

Further, in the step (1), the polarization dark channel is expressed as:

$${I}^{D} ( X ) = {min}_{Y ∈ Ω ( X )} ( {min}_{c ∈ C} {I}^{c} ( Y ) )$$

wherein, C=[r,g,b,r₀,g₀,b₀,r₄₅,g₄₅,b₄₅,r₉₀,g₉₀,b₉₀,r₁₃₅,g₁₃₅,b₁₃₅]
wherein, r, g and b respectively represent red, green and blue channel polarization images, and r* represents a red channel polarization image at an angle *.

Further, in the step (1), the binary images of light intensity I^{H}, degree of polarization I^{DOP}, occlusion I^{S} and gradient ΔI are respectively expressed as:

$${I}^{H} = 1 ( {I}^{D} == {I}_{max} ) ,$$

$${I}^{DOP} = 1 ( 1 \% < {P}_{D} < 90 \% )$$

$${I}^{S} = 1 ( {I}^{D} == 0 )$$

$$Δ I = 1 ( ( Δ {P}_{D} + Δ {P}_{A} ) > T )$$

wherein, I^{D} represents each element in a polarization dark channel image matrix, Iₘₐₓ represents a maximum light intensity acceptable by a sensor, P_{D} represents the degree of polarization, ΔP_{D} represents the gradient of the degree of polarization, ΔP_{A} represents the gradient of the angle of polarization, T is a gradient threshold, and 1 represents an indicator function.

Further, in the step (2), a setting method of the number of clusters comprises:
(a) setting an initial value of the number of clusters kₒ as 1;
(b) when occlusion exists, updating the number of clusters to be:

$${k}_{o} = {k}_{o} + 1 , ( {\sum }_{{S}_{i} ∈ {I}^{S}} {S}_{i} ) > 0 ;$$

(c) setting an intensity threshold as wNM, and as for whether the light intensity exceeds wNM, further updating the number of clusters obtained in the step (b) to be:

$$\{ \begin{matrix}{k}_{o} = {k}_{o} + 2 , ( {\sum }_{{H}_{i} ∈ {I}^{H}} {H}_{i} ) > wNM \\ {k}_{o} = {k}_{o} + 1 , 0 < ( {\sum }_{{H}_{i} ∈ {I}^{H}} {H}_{i} ) < wNM\end{matrix} .$$

Further, in the step (3), an acquisition method of the sky region image Ω_{sc} through the polarization dark channel clustergram is:

$${Ω}_{SC} = {μ}_{sc} ⋂ Δ I ⋂ {I}^{H} ⋂ {I}^{S}$$

wherein, μ_{SC} represents a sky type, and μ_{sc}=1^{K}(μₛ==0, μₕ==0, μₘ==0)
wherein, I^{K} represents the polarization dark channel clustergram, μ_{S} is an occlusion type, μₕ is an intensity type, and μₘ is a blur type,

$${μ}_{s} ← arg {max}_{{μ}_{k}} ( {\sum }_{{μ}_{k} ∈ μ} {I}_{{μ}_{k}}^{K} {I}^{S} )$$

$${μ}_{h} ← arg {max}_{{μ}_{k}} ( {\sum }_{{μ}_{k} ∈ μ} {I}_{{μ}_{k}}^{K} {I}^{H} )$$

$${μ}_{m} ← arg {max}_{{μ}_{k}} ( \frac{1}{{N}_{k}} {\sum }_{{μ}_{k} ∈ μ} {I}_{{μ}_{k}}^{K} Δ I ) ,$$

wherein, μ represents a set of all types updated from the number of cluster number kₒ, μₖ represents a k^{th} type, k∈{1, 2, . . . k₀}, and Nₖ is a total number of individuals in the k^{th} type.

Further, in the step (4), an acquisition method of the feature binary image of the angle of polarization AOP_{b0} is:

$${AOP}_{b 0} ( find ( ρ == {cosh}_{s} cos ( θ - {A}_{s} ) ) ) = 1 ,$$

wherein, find(*) represents a set of coordinates satisfying *,

$$\{ \begin{matrix}ρ = {sinh}_{s} {coth}_{p} \\ θ = {A}_{p}\end{matrix}$$

wherein, hₛ is a solar altitude, hₚ is an observation point altitude angle, and A, is an observation point azimuth angle.

Further, in the step (6), the sun position and the reverse sun position are obtained by matching according to the sun position binary feature map:

$$ξ = \{ \begin{matrix}{ξ}^{+} ( {h}_{s}^{+} , {A}_{s}^{+} ) \\ {ξ}^{-} ( {h}_{s}^{-} , {A}_{s}^{-} )\end{matrix}$$

a constraint term is added:

$${ξ}_{t} = ξ , s . t . sign ( ξ ) > 0$$

wherein, ξ represents the sun position, ξ⁺ is a sun position above the horizontal plane, ξ⁻ is a sun position below the horizontal plane, hₛ⁺, is a solar altitude above the horizontal plane, Aₛ⁺ is a solar azimuth above the horizontal plane, hₛ⁻ is a solar altitude below the horizontal plane, Aₛ⁻ is a solar azimuth below the horizontal plane, and ξₜ represents the real sun position; and
the real sun position is obtained according to the sun position, the reverse sun position and the constraint term, which is recorded as ξₜ (hₛ, Aₛ).

Further, in the step (7), the sun position deviation is calculated as:

$$δ ∝ sd ( {δ}_{b 0} ) ∝ sd ( \frac{\tilde{Y}}{\tilde{X}} )$$

wherein, δ represents the sun position deviation, δ_{b0} represents a deviation of the feature binary image of the angle of polarization AOP_{b0}, \tilde{X} represents cos (Aₚ−Aₛ), \tilde{Y} represents cothₚ, and Aₛ is the solar azimuth.

Further, in the step (8), the course angle \tilde{ψ}_{nb} is:

$${\vec{ψ}}_{nb} = {tan}_{2}^{- 1} ( - {\tilde{s}}_{y}^{b} cos {ϕ}_{nb} + {\tilde{s}}_{z}^{b} sin {ϕ}_{nb} , {\tilde{s}}_{x}^{b} cos {θ}_{nb} + {\tilde{s}}_{y}^{b} sin {ϕ}_{nb} sin {θ}_{nb} + {\tilde{s}}_{z}^{b} cos {ϕ}_{nb} sin {θ}_{nb} ) + {A}_{s}$$

wherein, θ_{nb} is a pitch angle, and ϕ_{nb} is a roll angle, which are measured by an additional sensor,

$${[ \begin{matrix}{\tilde{s}}_{x}^{b} & {\tilde{s}}_{y}^{b} & {\tilde{s}}_{z}^{b}\end{matrix} ]}^{T} = [ \begin{matrix}cos {Ã}_{s}^{b} cos {\tilde{h}}_{s}^{b} \\ sin {Ã}_{s}^{b} cos {\tilde{h}}_{s}^{b} \\ sin {\tilde{h}}_{s}^{b}\end{matrix} ]$$

wherein,

$${\tilde{h}}_{s}^{b} = π - {cos}^{- 1} ( z \sqrt{{x}^{2} / {y}^{2} + 1} / x )$$

$${Ã}_{s}^{b} = - {tan}^{- 1} ( x / y )$$

(1) wherein, x, y and z are defined as:

$$[ \begin{matrix}{x}^{2} & xy & xz \\ xy & {y}^{2} & yz \\ xz & yz & {z}^{2}\end{matrix} ] \hat{=} \frac{1}{NM} \text{?} ( {e}_{ij} \text{?} )$$

$$\text{?} \text{indicates text missing or illegible when filed}$$

wherein, NM is a total number of pixels, and eᵢⱼ is a measured angle of polarization, wherein {i,j|Ω_{SC}(i,j)=1}.

Beneficial effects: compared with the prior art, the polarization orientation method based on sky region prior and morphological template matching of transform domain provided by the present invention can realize course angle measurement under an interference of reflected light of objects such as trees and buildings, which has a small error, and can complete high-robustness sun blur judgment without relying on an additional sensor, which avoids an additional cost, thus effectively improving the accuracy and robustness of a course angle measurement method based on an atmospheric polarization mode.

Compared an existing orientation method based on scattered light of atmosphere, this method visualizes navigation information and improves the robustness of orientation; and this method provides a transform domain model for an angle of polarization, introduces template matching to solve the sun blur of the binary feature map, and gives the accurate sky region based on the polarization dark channel and the region prior before orientation, thus realizing the course angle measurement when a part of scattered light of sky is destroyed by reflected light.

### BRIEF DESCRIPTION OF THE DRAWINGS

FIG. 1 is a frame flow chart of a polarization orientation method based on sky region prior and morphological template matching of transform domain;

FIG. 2 is a schematic diagram of a result of sun blur judgment by the polarization orientation method based on sky region prior and morphological template matching of transform domain; and

FIG. 3 is a schematic diagram of a result of orientation error measurement by the polarization orientation method based on sky region prior and morphological template matching of transform domain.

### DETAILED DESCRIPTION

The present invention is further explained and described hereinafter with reference to the drawings and specific embodiments.

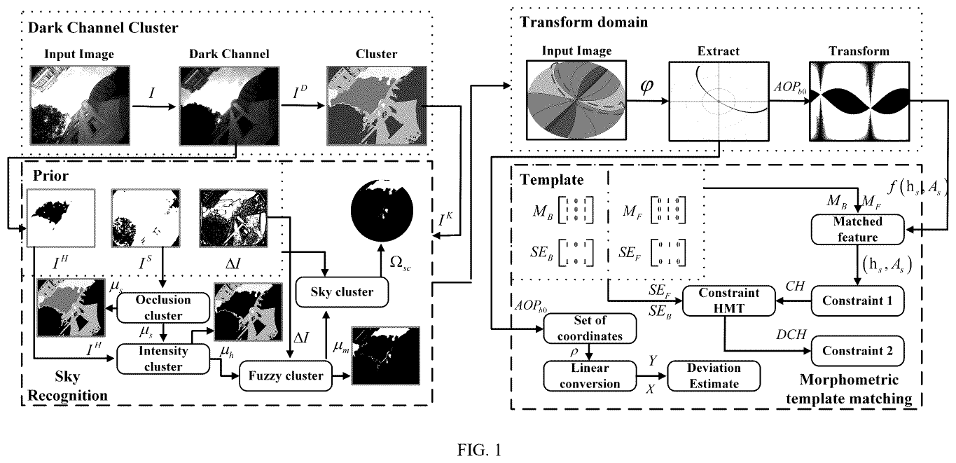

A polarization orientation method based on sky region prior and morphological template matching of transform domain, as shown in FIG. 1, comprises a computer readable medium operable on a computer with memory for the polarization orientation method, and comprising program instructions for executing the following steps.

(1) A polarization dark channel image, a degree of polarization, a gradient of the degree of polarization and a gradient of an angle of polarization are calculated by using 0°, 45°, 90° and 135° images shot by a polarization camera, a light intensity binary image and an occlusion binary image are calculated according to the polarization dark channel image, a binary image of the degree of polarization is calculated according to the degree of polarization, and a gradient binary image is calculated according to the gradient of the degree of polarization and the gradient of the angle of polarization. Specifically:

the binary images of light intensity I^{H}, degree of polarization I^{DOP}, occlusion I^{S} and gradient ΔI are respectively expressed as:

$${I}^{H} = 1 ( {I}^{D} == {I}_{max} ) ,$$

$${I}^{DOP} = 1 ( 1 \% < {P}_{D} < 90 \% )$$

$${I}^{S} = 1 ( {I}^{D} == 0 )$$

$$Δ I = 1 ( ( Δ {P}_{D} + Δ {P}_{A} ) > T )$$

wherein, I^{D} represents each element in a polarization dark channel image matrix, Iₘₐₓ represents a maximum light intensity acceptable by a sensor, P_{D} represents the degree of polarization, ΔP_{D} represents the gradient of the degree of polarization, ΔP_{A} represents the gradient of the angle of polarization, T is a gradient threshold, and 1 represents an indicator function.

The polarization dark channel image is expressed as:

$${I}^{D} ( X ) = {min}_{Y ∈ Ω ( X )} ( {min}_{c ∈ C} {I}^{c} ( Y ) )$$

wherein, C=[r,g,b,r₀,g₀,b₀,r₄₅,g₄₅,b₄₅,r₉₀,g₉₀,b₉₀,r₁₃₅,g₁₃₅,b₁₃₅]
wherein, r, g and b respectively represent red, green and blue channel polarization images, and r* represents a red channel polarization image at an angle *.

(2) A number of clusters is set according to the light intensity binary image and the occlusion binary image.

A setting method of the number of clusters comprises:
(a) setting an initial value of the number of clusters kₒ as 1;
(b) when occlusion exists, updating the number of clusters to be:

$${k}_{o} = {k}_{o} + 1 , ( {\sum }_{{S}_{i} ∈ {I}^{S}} {S}_{i} ) > 0 ;$$

(c) setting an intensity threshold as wNM, and as for whether the light intensity exceeds wNM, further updating the number of clusters obtained in the step (b) to be:

$$\{ \begin{matrix}{k}_{o} = {k}_{o} + 2 , & ( {\sum }_{{H}_{i} ∈ {I}^{H}} , {H}_{i} ) > wNM \\ {k}_{o} = {k}_{o} + 1 , & 0 < ( {\sum }_{{H}_{i} ∈ {I}^{H}} , {H}_{i} ) < wNM\end{matrix} .$$

(3) Polarization dark channel clustering is carried out according to the set number of clusters to obtain a polarization dark channel clustergram, and a sky region image is acquired through the polarization dark channel clustergram by an acquisition method as follows:

$${Ω}_{SC} = {μ}_{sc} ⋂ Δ I ⋂ {I}^{H} ⋂ {I}^{S}$$

wherein, μ_{sc} represents a sky type, and μ_{sc}=I^{K} (μₛ=0, μₕ=0, μₘ=0)
wherein, I^{K} represents the polarization dark channel clustergram, μₛ is an occlusion type, μₕ is an intensity type, and μₘ is a blur type,

$${μ}_{s} ← arg {max}_{{μ}_{k}} ( {\sum }_{{μ}_{k} ∈ μ} {I}_{{μ}_{k}}^{K} {I}^{S} )$$

$${μ}_{h} ← arg {max}_{{μ}_{k}} ( {\sum }_{{μ}_{k} ∈ μ} {I}_{{μ}_{k}}^{K} {I}^{H} )$$

$${μ}_{m} ← arg {max}_{{μ}_{k}} ( \frac{1}{{N}_{k}} {\sum }_{{μ}_{k} ∈ μ} {I}_{{μ}_{k}}^{K} Δ I )$$

wherein, μ represents a set of all types updated from the number of cluster number kₒ,
μₖ represents a k^{th} type, k∈{1, 2, . . . k₀}, and Nₖ is a total number of individuals in the k^{th} type.

(4) An image of the angle of polarization is calculated, and feature extraction is carried out on the image of the angle of polarization to obtain a feature binary image of the angle of polarization, which is expressed as:

$$A O {P}_{b 0} ( find ( ρ = = {cosh}_{s} cos ( θ - {A}_{s} ) ) ) = 1 ,$$

wherein, find(*) represents a set of coordinates satisfying *,

$$\{ \begin{matrix}ρ & = {sinh}_{s} {coth}_{p} \\ θ & = {A}_{p}\end{matrix}$$

wherein, hₛ is a solar altitude, hₚ is an observation point altitude angle, and Aₚ is an observation point azimuth angle.

(5) A two-dimensional plane is constructed by taking (0°, 360°] and [−90°, 90°] as horizontal and vertical directions respectively, and the feature binary image of the angle of polarization is projected onto the two-dimensional plane by a space domain transform method to obtain a sun position binary feature map.

(6) A sun position and a reverse sun position are obtained by matching according to the sun position binary feature map:

$$ξ = \{ \begin{matrix}{ξ}^{+} ( {h}_{s}^{+} , {A}_{s}^{+} ) \\ {ξ}^{-} ( {h}_{s}^{-} , {A}_{s}^{-} )\end{matrix}$$

because the sun is located above the horizontal plane, a constraint condition is set,

$${ξ}_{t} = \partial ξ , s . t . sign ( ξ ( x ) ) > 0$$

wherein, ξ represents the sun position, ξ⁺ is a sun position above the horizontal plane, ξ⁻ is a sun position below the horizontal plane, hₛ⁺ is a solar altitude above the horizontal plane, Aₛ⁺ is a solar azimuth above the horizontal plane, hₛ⁻ is a solar altitude below the horizontal plane, Aₛ⁻ is a solar azimuth below the horizontal plane, and ξₜ represents the real sun position; and
a real sun position is obtained according to the sun position, the reverse sun position and the constraint term, which is recorded as ξₜ(hₛ,A_{S}).

(7) A difference between a Rayleigh scattering model and a real atmospheric model is ignored, a sun position deviation is calculated, and a detection result is considered to be true and reliable when the deviation is less than a threshold Tₘ; and the detection result is considered to be unreliable when the deviation is greater than the threshold, and subsequently, the deviation may be detected and calculated again.

The sun position deviation is calculated as:

$$δ ∝ sd ( {δ}_{b 0} ) ∝ sd ( \frac{\tilde{Y}}{\tilde{X}} )$$

wherein, δ represents the sun position deviation, δ_{b0} represents a deviation of the feature binary image of the angle of polarization AOP_{b0}, \tilde{X} represents cos (Aₚ−Aₛ), \tilde{Y} represents cothₚ, and Aₛ is the solar azimuth. δ_{b0} is in direct proportion to

$$\frac{\tilde{Y}}{\tilde{X}} ,$$

and

the calculated sun position deviation is represented by a standard deviation of

$$\frac{\tilde{Y}}{\tilde{X}} ,$$

which

may be simplified as

$$δ ∝ sd ( \frac{\tilde{Y}}{\tilde{X}} ) .$$

(8) A course angle is calculated by combining the angle of polarization with the sky region image, and the course angle \tilde{ψ}_{nb} is:

$${\tilde{ψ}}_{nb} = {tan}_{2}^{- 1} ( - {\tilde{s}}_{y}^{b} cos {ϕ}_{nb} + {\tilde{s}}_{z}^{b} sin {ϕ}_{nb} , {\tilde{s}}_{x}^{b} cos {θ}_{nb} + {\tilde{s}}_{y}^{b} sin {ϕ}_{nb} sin {θ}_{nb} + {\tilde{s}}_{z}^{b} cos {ϕ}_{nb} sin {θ}_{nb} ) + {A}_{s}$$

wherein, θ_{nb} is a pitch angle, and ϕ_{nb} is a roll angle, and the pitch angle and the roll angle are measured by an additional sensor, such as an inertial navigation system.

$${[ \begin{matrix}{\tilde{s}}_{x}^{b} & {\tilde{s}}_{y}^{b} & {\tilde{s}}_{z}^{b}\end{matrix} ]}^{T} = [ \begin{matrix}cos {\tilde{A}}_{s}^{b} cos {\tilde{h}}_{s}^{b} \\ sin {\tilde{A}}_{s}^{b} cos {\tilde{h}}_{s}^{b} \\ sin {\tilde{h}}_{s}^{b}\end{matrix} ]$$

wherein,

$${\tilde{h}}_{s}^{b} = π - {cos}^{- 1} ( z \sqrt{{x}^{2} / {y}^{2} + 1} / x )$$

$${\tilde{A}}_{s}^{b} = - {tan}^{- 1} ( x / y )$$

(1) wherein, x, y and z are defined as:

$$[ \begin{matrix}{x}^{2} & xy & xz \\ xy & {y}^{2} & yz \\ xz & yz & {z}^{2}\end{matrix} ] {=}^{Δ} \frac{1}{NM} {\sum }_{ij} ( {e}_{ij} {e}_{ij}^{T} )$$

wherein, NM is a total number of pixels, and eᵢⱼ is a measured angle of polarization, wherein {i,j|Ω_{SC}(i,j)=1}; and

(9) Provides a transform domain model for an angle of polarization, introduces template matching to solve a sun blur of a binary feature map that resulted in an accurate sky region based on the polarization orientation method, therefore, improving a robustness of orientation.

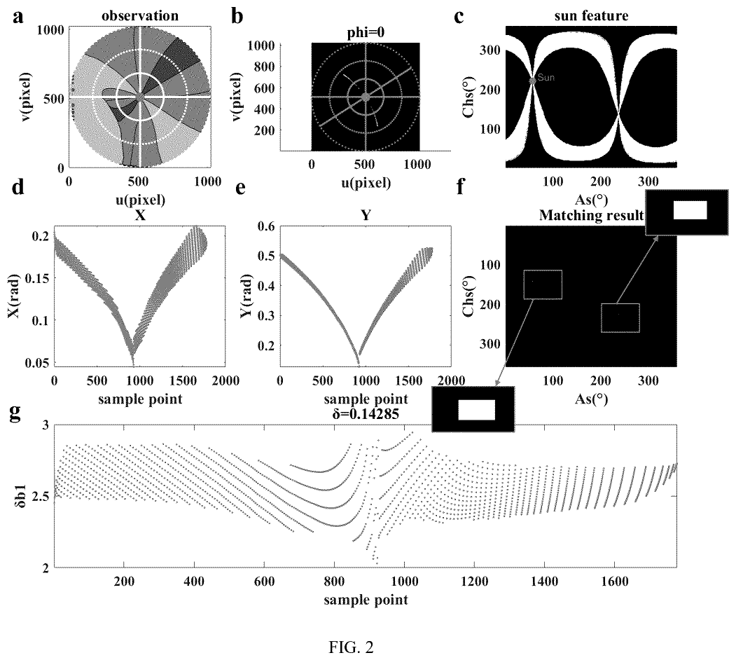

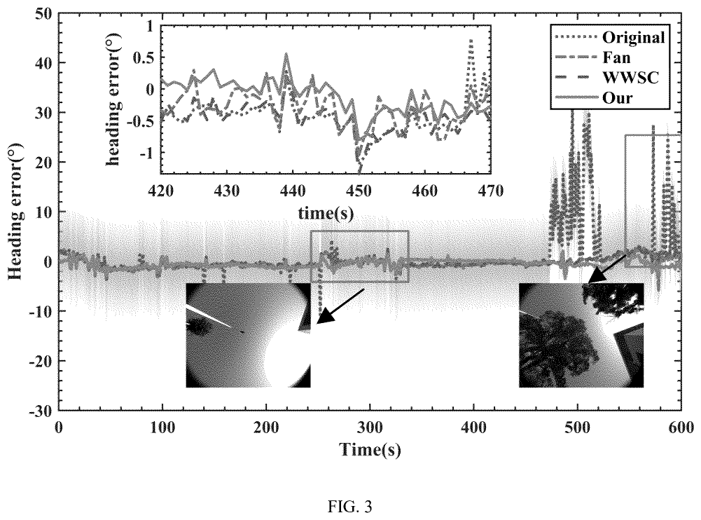

The effect of this method is verified hereinafter by a vehicle-mounted test. FIG. 2 is a schematic diagram of a result of sun blur judgment by this method. FIG. 3 shows comparison of vehicle-mounted orientation errors of different polarization orientation methods. The orientation methods used in the comparison comprise: traditional direct orientation by polarized light, orientation by the gradient of the degree of polarization (Fan) and orientation by weather-weighted sparse coding (WWSC). It can be seen from FIG. 3 that the method in this embodiment has the highest accuracy under an interference of reflected light, and shows good robustness under different conditions.

According to the method, a region division standard is given through sky region prior, and the sky region is identified by clustering the darkest pixel images in 15-channel polarization images. Meanwhile, the MTMTD strategy provided carries out a transform domain treatment on the image of the angle of polarization by an imaging method, and solves the problem of sun blur under the single Rayleigh scattering model without relying on the additional sensor. According to the method, the orientation can be completed in the case that the sky is occluded and interfered under a ground/near-ground condition, and the accuracy and robustness of course measurement based on atmospheric polarized light are effectively improved.

What is claimed is:

1. A polarization orientation method based on sky region prior and morphological template matching of transform domain, comprising a computer readable medium operable on a computer with memory for the polarization orientation method, and comprising program instructions for executing the following steps of:
(1) calculating a polarization dark channel image, a degree of polarization, a gradient of the degree of polarization and a gradient of an angle of polarization by using 0°, 45°, 90° and 135° images shot by a polarization camera, calculating a light intensity binary image and an occlusion binary image according to the polarization dark channel image, calculating a binary image of the degree of polarization according to the degree of polarization, and calculating a gradient binary image according to the gradient of the degree of polarization and the gradient of the angle of polarization;
(2) setting a number of clusters according to the light intensity binary image and the occlusion binary image;
(3) carrying out polarization dark channel clustering according to the set number of clusters to obtain a polarization dark channel clustergram, and acquiring a sky region image through the polarization dark channel clustergram;
(4) calculating an image of the angle of polarization, and carrying out feature extraction on the image of the angle of polarization to obtain a feature binary image of the angle of polarization;
(5) constructing a two-dimensional plane by taking (0°, 360°] and [−90°, 90°] as horizontal and vertical directions respectively, and projecting the feature binary image of the angle of polarization onto the two-dimensional plane by a space domain transform method to obtain a sun position binary feature map;
(6) obtaining a sun position and a reverse sun position by matching according to the sun position binary feature map, and determining a real sun position according to a constraint condition that the sun is above a horizontal plane;
(7) ignoring a difference between a Rayleigh scattering model and a real atmospheric model, calculating a sun position deviation, and considering a detection result to be true and reliable when the deviation is less than a threshold Tₘ; and considering the detection result to be unreliable when the deviation is greater than the threshold;
(8) calculating a course angle by combining the angle of polarization with the sky region image; and
(9) providing a transform domain model for an angle of polarization, introduces template matching to solve a sun blur of a binary feature map that resulted in an accurate sky region based on the polarization orientation method, therefore, improving a robustness of orientation.

2. The polarization orientation method based on sky region prior and morphological template matching of transform domain according to claim 1, wherein, in the step (1), the polarization dark channel is expressed as:
$${I}^{D} ( X ) = {min}_{Y ∈ Ω ( X )} ( {min}_{c ∈ C} {I}^{c} ( Y ) )$$
wherein, C=[r,g,b,r₀,g₀,b₀,r₄₅,g₄₅,b₄₅,r₉₀,g₉₀,b₉₀,r₁₃₅,g₁₃₅,b₁₃₅],
wherein, r, g and b respectively represent red, green and blue channel polarization images, and r* represents a red channel polarization image at an angle *.

3. The polarization orientation method based on sky region prior and morphological template matching of transform domain according to claim 1, wherein, in the step (1), the binary images of light intensity I^{H}, degree of polarization I^{DOP}, occlusion I^{S} and gradient ΔI are respectively expressed as:
$${I}^{H} = 1 ( {I}^{D} == {I}_{max} ) ,$$
$${I}^{D O P} = 1 ( 1 \% < {P}_{D} < 90 \% )$$
$${I}^{S} = 1 ( {I}^{D} == 0 )$$
$$Δ I = 1 ( ( Δ {P}_{D} + Δ {P}_{A} ) > T )$$
wherein, I^{D} represents each element in a polarization dark channel image matrix, Iₘₐₓ represents a maximum light intensity acceptable by a sensor, P_{D} represents the degree of polarization, ΔP_{D} represents the gradient of the degree of polarization, ΔP_{A} represents the gradient of the angle of polarization, T is a gradient threshold, and 1 represents an indicator function.

4. The polarization orientation method based on sky region prior and morphological template matching of transform domain according to claim 1, wherein, in the step (2), a setting method of the number of clusters comprises:
(a) setting an initial value of the number of clusters kₒ as 1;
(b) when occlusion exists, updating the number of clusters to be:
$${k}_{o} = {k}_{o} + 1 , ( {\sum }_{{S}_{i} ∈ {I}^{S}} {S}_{i} ) > 0 ;$$
and
(c) setting an intensity threshold as wNM, and as for whether the light intensity exceeds wNM, further updating the number of clusters obtained in the step (b) to be:
$$\{ \begin{matrix}{k}_{o} = {k}_{o} + 2 , ( {\sum }_{{H}_{i} ∈ {I}^{H}} {H}_{i} ) > wNM \\ {k}_{o} = {k}_{o} + 1 , 0 < ( {\sum }_{{H}_{i} ∈ {I}^{H}} {H}_{i} ) < wNM\end{matrix} .$$

5. The polarization orientation method based on sky region prior and morphological template matching of transform domain according to claim 3, wherein, in the step (3), an acquisition method of the sky region image Ω_{sc} through the polarization dark channel clustergram is:
$${Ω}_{SC} = {μ}_{sc} ⋂ Δ I ⋂ {I}^{H} ⋂ {I}^{S}$$
wherein, μ_{sc} represents a sky type, and μ_{sc}=I^{K}(μs==0, μh==0, μm==0),
wherein, I^{K} represents the polarization dark channel clustergram, μₛ is an occlusion type, μₕ is an intensity type, and μₘ is a blur type,
$${μ}_{s} ← arg {max}_{{μ}_{k}} ( {\sum }_{{μ}_{k} ∈ μ} {I}_{{μ}_{k}}^{K} {I}^{S} )$$
$${μ}_{h} ← arg {max}_{{μ}_{k}} ( {\sum }_{{μ}_{k} ∈ μ} {I}_{{μ}_{k}}^{K} {I}^{H} )$$
$${μ}_{m} ← arg {max}_{{μ}_{k}} ( \frac{1}{{N}_{k}} {\sum }_{{μ}_{k} ∈ μ} {I}_{{μ}_{k}}^{K} Δ I ) ,$$
wherein, μ represents a set of all types updated from the number of cluster number kₒ, μₖ represents a k^{th} type, k∈{1, 2, . . . k₀}, and Nₖ is a total number of individuals in the k^{th} type.

6. The polarization orientation method based on sky region prior and morphological template matching of transform domain according to claim 1, wherein, in the step (4), an acquisition method of the feature binary image of the angle of polarization AOP_{b0} is:
$${AOP}_{b 0} ( find ( ρ == {cosh}_{s} cos ( θ - {A}_{s} ) ) ) = 1 ,$$
wherein, find(*) represents a set of coordinates satisfying *,
$$\{ \begin{matrix}ρ = {sinh}_{s} {coth}_{p} \\ θ = {A}_{p}\end{matrix}$$
wherein, hₛ is a solar altitude, hₚ is an observation point altitude angle, and Aₚ is an observation point azimuth angle.

7. The polarization orientation method based on sky region prior and morphological template matching of transform domain according to claim 1, wherein, in the step (6), the sun position and the reverse sun position are obtained by matching according to the sun position binary feature map:
$$ξ = \{ \begin{matrix}{ξ}^{+} ( {h}_{s}^{+} , {A}_{s}^{+} ) \\ {ξ}^{-} ( {h}_{s}^{-} , {A}_{s}^{-} )\end{matrix}$$
a constraint term is added:
$${ξ}_{t} = ξ , s . t . sign ( ξ ) > 0$$
wherein, ξ represents the sun position, ξ⁺ is a sun position above the horizontal plane, ξ⁻ is a sun position below the horizontal plane, hₛ⁺ is a solar altitude above the horizontal plane, Aₛ⁺ is a solar azimuth above the horizontal plane, hₛ⁻ is a solar altitude below the horizontal plane, Aₛ⁻ is a solar azimuth below the horizontal plane, and ξₜ represents the real sun position; and
the real sun position is obtained according to the sun position, the reverse sun position and the constraint term, which is recorded as ξₜ (hₛ, A_{S}).

8. The polarization orientation method based on sky region prior and morphological template matching of transform domain according to claim 7, wherein, in the step (7), the sun position deviation is calculated as:
$$δ ∝ s d ( {δ}_{b 0} ) ∝ sd ( \frac{\tilde{Y}}{\tilde{X}} )$$
wherein, δ represents the sun position deviation, δ_{b0} represents a deviation of the feature binary image of the angle of polarization AOP_{b0}, \tilde{X} represents cos (Aₚ−Aₛ), \tilde{Y} represents cothₚ, and Aₛ is the solar azimuth.

9. The polarization orientation method based on sky region prior and morphological template matching of transform domain according to claim 1, wherein, in the step (8), the course angle \tilde{ψ}_{nb} is:
$${\tilde{ψ}}_{n b} = {tan}_{2}^{- 1} ( - {\tilde{s}}_{y}^{b} cos {ϕ}_{n b} + {\tilde{s}}_{z}^{b} sin {ϕ}_{n b} , \\ {\tilde{s}}_{x}^{b} cos {θ}_{n b} + {\tilde{s}}_{y}^{b} sin {ϕ}_{n b} sin {θ}_{n b} + {\tilde{s}}_{z}^{b} cos {ϕ}_{n b} sin {θ}_{n b} ) + {A}_{s}$$
wherein, θ_{nb} is a pitch angle, and ϕ_{nb} is a roll angle, which are measured by an additional sensor,
$${[ \begin{matrix}{\tilde{s}}_{x}^{b} & {\tilde{s}}_{y}^{b} & {\tilde{s}}_{z}^{b}\end{matrix} ]}^{T} = [ \begin{matrix}cos {\tilde{A}}_{s}^{b} cos {\tilde{h}}_{s}^{b} \\ sin {\tilde{A}}_{s}^{b} cos {\tilde{h}}_{s}^{b} \\ sin {\tilde{h}}_{s}^{b}\end{matrix} ]$$
wherein,
$${\tilde{h}}_{s}^{b} = π - {cos}^{- 1} ( z \sqrt{{x}^{2} / {y}^{2} + 1} / x )$$
$${\tilde{A}}_{s}^{b} = - {tan}^{- 1} ( x / y )$$
wherein, x, y and z are defined as:
$$[ \begin{matrix}{x}^{2} & xy & xz \\ xy & {y}^{2} & yz \\ xz & yz & {z}^{2}\end{matrix} ] {=}^{Δ} \frac{1}{NM} {\sum }_{\text{?}} ( {e}_{ij} {e}_{ij}^{T} )$$
$$\text{?} \text{indicates text missing or illegible when filed}$$
wherein, NM is a total number of pixels, and eᵢⱼ is a measured angle of polarization, wherein {i,j|Ω_{SC}(i,j)==1}.
